(19) United States
(12) Patent Application Publication
(10) Pub. No.: US 2019/0375076 A1
(43) Pub. Date: Dec. 12, 2019

(54) SWITCH ASSEMBLY FOR A RATCHET WRENCH

(71) Applicant: Hui-Hsueh Chung, Taichung City (TW)

(72) Inventor: Hui-Hsueh Chung, Taichung City (TW)

(21) Appl. No.: 16/001,908

(22) Filed: Jun. 6, 2018

(51) Int. Cl. B25B 13/46

(52) U.S. Cl. CPC B25B 13/468; B25B 13/463

(57) ABSTRACT

A ratchet wrench includes a head for receiving a toothed wheel and two detents. A switch assembly includes an auxiliary element, a disc and a switch. The auxiliary element includes a horizontal plate supported on the handle and a vertical plate with two slant portions. The disc includes an engaging aperture between two hooks. The switch includes a central aperture and an extension inserted in the engaging aperture so that the disc and the switch are rotatable together. A screw is inserted in the handle through the central aperture of the switch and the engaging aperture of the disc. The switch is operable to rotate the disc to cause one of the hooks to hook and engage the first detent with the toothed wheel while the second detent pushes one of the slant portions so that the other slant portion pushes the first detent against the toothed wheel.

### BACKGROUND OF INVENTION

### 1. Field of Invention

The present invention relates to a ratchet wrench and, more particularly, to a switch assembly for a ratchet wrench.

### 2. Related Prior Art

A ratchet wrench is provided with a switch assembly that includes a disc and an auxiliary element. The disc includes an arched cutout between two hooks. An axle is formed on the disc. The axle includes an arched face between a first flat face and a second flat face. The first flat face is connected to the second flat face at an apex. The auxiliary element is arranged around the axle. The auxiliary element includes two flat portions and two arched portions. The flat portions are interconnected at a connective portion. The arched portions extend from the flat portions toward a gap, near the connective portion of the flat portions. Thus, the arched portions extend near the arched face. The auxiliary element is used to contact a detent assembly. Thus, the switch assembly is operable to cause the detent assembly to efficiently engage with a driver. However, this conventional switch assembly involves a complicated structure.

A ratchet wrench is provided with a switch assembly that includes a disc and an auxiliary element inserted in a chamber in the ratchet wrench so that the disc is connected to a switch. The disc includes two hooks and. An axle extends from the disc and includes a first face and a second face. The auxiliary element extends around the axle and includes a first flat portion and a second flat portion. For example, when the hook hooks a detent, the detent cooperates with the first face to clamp the first flat portion so that the second flat portion cooperates with a spring to keep another detent against the driver. However, this conventional switch assembly also involves a complicated structure.

The present invention is therefore intended to obviate or at least alleviate the problems encountered in prior art.

### SUMMARY OF INVENTION

It is the primary objective of the present invention to provide a ratchet wrench with a simple and effective switch assembly.

To achieve the foregoing objective, the ratchet wrench includes a head for receiving a toothed wheel and two detents. The switch assembly includes an auxiliary element, a disc and a switch. The auxiliary element includes a horizontal plate supported on the handle and a vertical plate with two slant portions. The disc includes an engaging aperture between two hooks. The switch includes a central aperture and an extension inserted in the engaging aperture so that the disc and the switch are rotatable together. A screw is inserted in the handle through the central aperture of the switch and the engaging aperture of the disc. The switch is operable to rotate the disc to cause one of the hooks to hook and engage the first detent with the toothed wheel while the second detent pushes one of the slant portions so that the other slant portion pushes the first detent against the toothed wheel.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a ratchet wrench according to the first embodiment of the present invention;

FIG. 2 is an enlarged cut-away view of a head of the ratchet wrench shown in FIG. 1;

FIG. 3 is an enlarged, partial and cross-sectional view of the ratchet wrench shown in FIG. 1;

FIG. 4 is a perspective view of a toothed wheel, two detents and a switch assembly of the ratchet wrench shown in FIG. 1;

FIG. 5 is a cross-sectional view of the toothed wheel, the detents and the switch assembly shown in FIG. 4;

FIG. 6 is another cross-sectional view of the toothed wheel, the detents and the switch assembly shown in FIG. 5;

FIG. 7 is an enlarged perspective view of a switch of the switch assembly shown in FIG. 4;

FIG. 8 is an enlarged perspective view of a disc of the switch assembly shown in FIG. 4;

FIG. 9 is an enlarged top view of an auxiliary element of the switch assembly shown in FIG. 4;

FIG. 10 is a perspective view of the auxiliary element shown in FIG. 9; and

FIG. 11 is a perspective view of a ratchet wrench according to the second embodiment of the present invention.

### DETAILED DESCRIPTION OF EMBODIMENTS

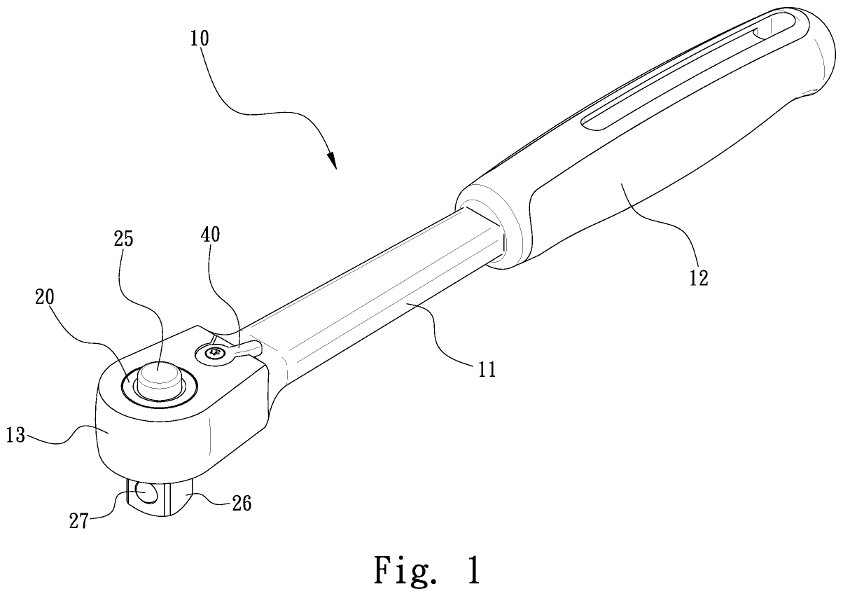

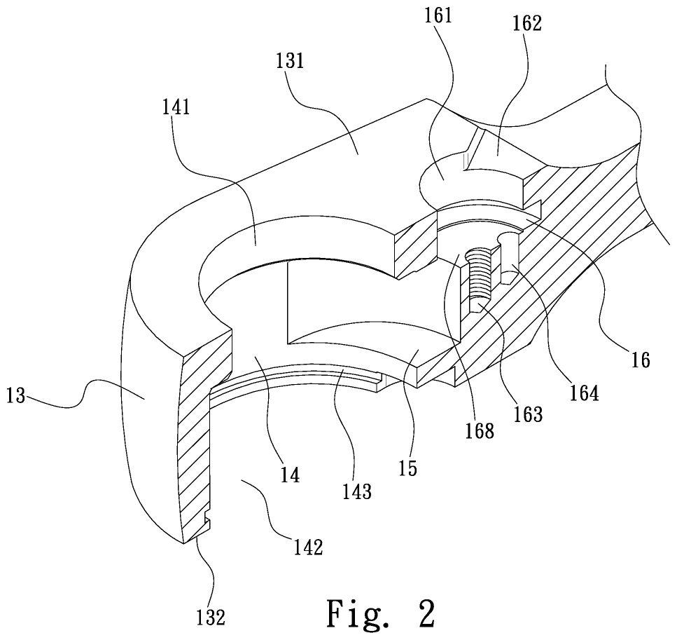

Referring to FIGS. 1 and 2, a ratchet wrench 10 includes a handle 11, a toothed wheel 20, two detents 30 and a switch assembly 40 according to a first embodiment of the present invention. The handle 11 includes an end inserted in a grip 12 and an opposite end formed as an enlarged hollow head 13. The toothed wheel 20, the detents 30 and the switch assembly 40 are inserted in the head 13 of the handle 11.

The head 13 includes a primary chamber 14, an intermediate chamber 15 and a secondary chamber 16. The intermediate chamber 15 is a crescent chamber in communication with the primary chamber 14 on a side and in communication with the secondary chamber 16 on another side.

The primary chamber 14 includes a first opening 141 in an upper face 131 of the head 13 and a second opening 142 in a lower face 132 of the head 13.

The secondary chamber 16 includes an opening 161 at an end and a floor 168 at another end. The opening 161 is located in the upper face 131 of the head 13. A screw hole 163 is made in the floor 168, and so is a positioning bore 164. The positioning bore 164 receives a spring 166 and ball 167. The spring 166 biases the ball 167 so that a portion of the ball 167 is located out of the positioning bore 164.

The head 13 further includes a recess 162 in the upper face 131 thereof, next to the opening 161. The recess 162 is in communication with the secondary chamber 16.

The head 13 further includes an annular groove 143 in a wall of the primary chamber 14, near the lower face 132 of the head 13. The annular groove 143 is in communication with the primary chamber 14.

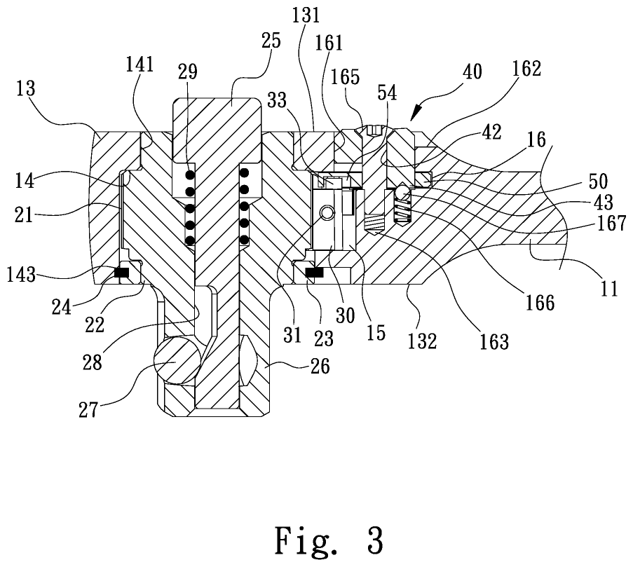

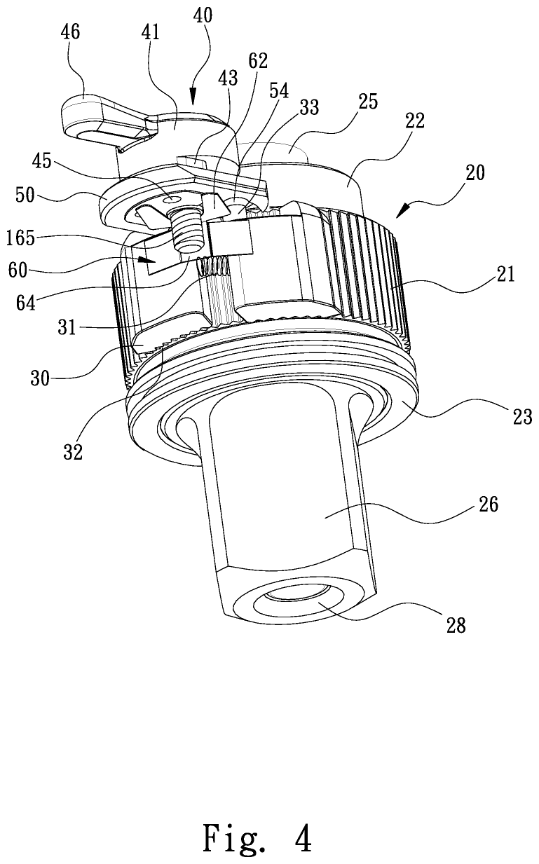

Referring to FIGS. 3 and 4, the toothed wheel 20 includes a plurality of teeth 21, two circular sections 22, a ring 23 and a non-circular insert 26. The teeth 21 extend from the periphery of a middle section of the toothed wheel 20.

The circular sections 22 of the toothed wheel 20 are made of a diameter smaller than that of the middle section of the toothed wheel 20. The circular sections 22 extend from two ends of the toothed wheel 20. For clarity, one of the circular sections 22 will be called “the first circular section 22” while the other circular section 22 will be referred to as “the second circular section 22.” When the toothed wheel 20 is inserted in the primary chamber 14, the first circular sections 22 is inserted in the first opening 141 of the head 13 while the second circular section 22 is inserted in the ring 23. An internal edge of a C-clip 24 is inserted in an annular groove (not numbered) in the ring 23. An external edge of the C-clip 24 is inserted in the annular groove 143. Thus, the ring 23 is retained in the head 13. Hence, the toothed wheel 20 is kept in the head 13, without interfering rotation of the toothed wheel 20 relative to the head 13.

The non-circular insert 26 extends from the second circular section 22 of the toothed wheel 20. The toothed wheel 20 further includes an axial bore 28 extending throughout the toothed wheel 20, including the non-circular insert 26. The axial bore 28 includes several sections made of different diameters. The toothed wheel 20 further includes a radial bore (not numbered) in the non-circular insert 26. The radial bore is in communication with the axial bore 28.

A ball 27 is movably inserted in the non-circular insert 26. A middle portion of the ball 27 is inserted in the radial bore. An external portion of the ball 27 is located out of the radial bore. An internal portion of the ball 27 is inserted in the axial bore 28. The non-circular insert 26 extends beyond the lower face 132 of the head 13 as the toothed wheel 20 is inserted in the head 13. The pushing rod 25 is inserted in the axial bore 28 and abutted against the internal portion of the ball 27, thereby forcing the external portion of the ball 27 out of the radial bore, i.e., out of the non-circular insert 26. A spring 29 is inserted in the axial bore 28 and provided around the pushing rod 25. The spring 29 is compressed between an enlarged end of the pushing rod 25 and a shoulder (not numbered) of the axial bore 28 so that the enlarged end of the pushing rod 25 tends to extend beyond the upper face 131 of the head 13 and is used as a button and that the pushing rod 25 tends to cause the external portion of the ball 27 out of the non-circular insert 26. The enlarged end of the pushing rod 25 can be pushed into the axial bore 28 against the spring 29 so that a reduced portion of the pushing rod 25 is located next to the ball 27 to allow the ball 27 to enter the non-circular insert 26.

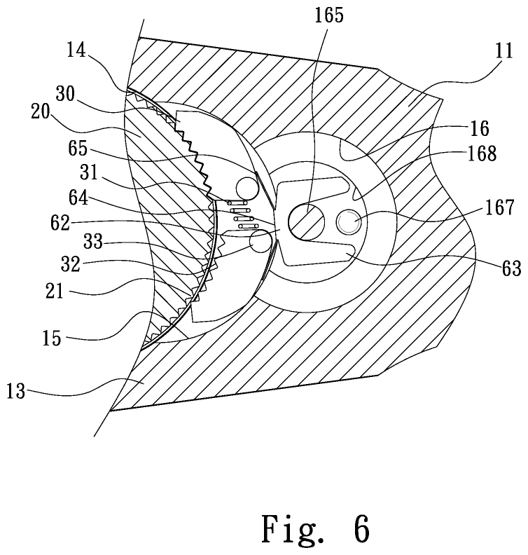

Referring to FIGS. 3 through 6, the detents 30 and a spring 31 are inserted in the intermediate chamber 15 of the head 13. The spring 31 includes two ends each of which is inserted in a recess 34 made in a corresponding one of the detents 30. The detents 30 are biased from each other by the spring 31 and guided toward the toothed wheel 20 by the wall of the intermediate chamber 15 of the head 13. The detents 30 are identical to each other in shape but located in opposite senses of direction. Each of the detents 30 includes a plurality of teeth 32 formed on a front face, a smooth rear face and a stem 33 formed on an upper face. The teeth 32 of at least one of the detents 30 are engaged with the teeth 21 of the toothed wheel 20.

The switch assembly 40 includes a switch 41, a disc 50 and an auxiliary element 60. All of the switch 41, the disc 50 and the auxiliary element 60 are substantially inserted in the secondary chamber 16.

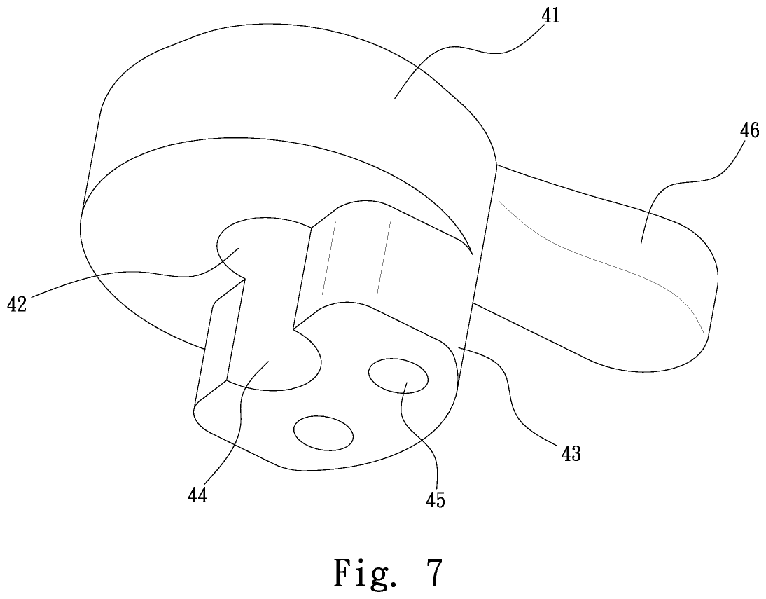

Referring to FIG. 7, the switch 41 is formed with a central aperture 42, a non-circular extension 43 and a lever 46. The non-circular extension 43 extends from a lower face of the switch 41. The non-circular extension 43 includes a semi-circular recess 44 in a front face thereof and preferably two positioning recesses 45 in a lower face thereof. The wall of the semi-circular recess 44 is an extension from the wall of the central aperture 42. The lever 46 extends from the periphery of the switch 41 in a radial sense of direction.

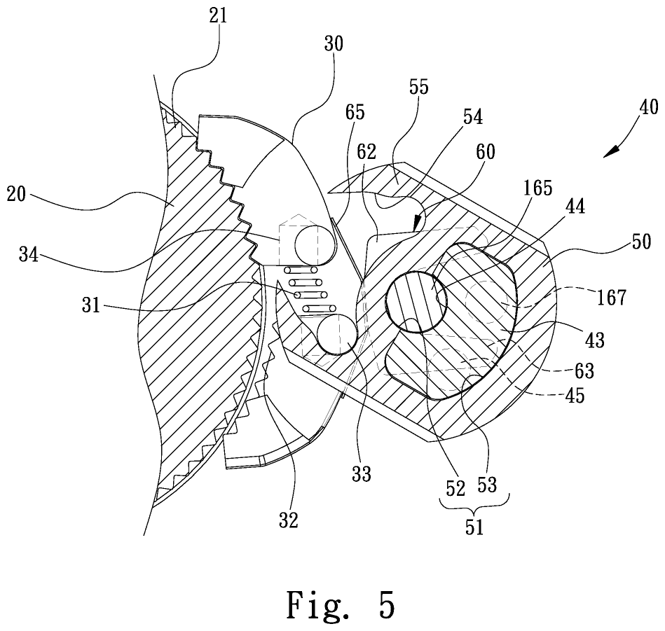

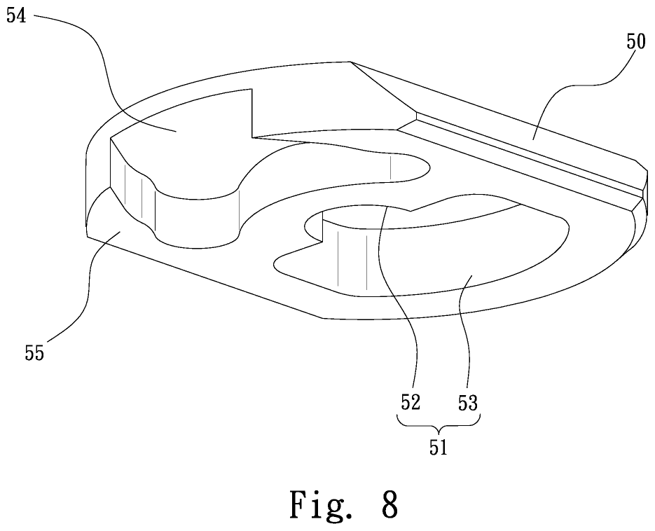

Referring to FIG. 8, the disc 50 includes two parallel rectilinear edges between two arched edges. The disc 50 further includes an engaging aperture 51 and a movement chamber 54. The engaging aperture 51 extends throughout the thickness of the disc 50. The engaging aperture 51 includes a semi-circular portion 52 and a non-circular portion 53. The diameter of the semi-circular portion 52 is substantially identical to that of the screw 165 (FIG. 5). The profile of the non-circular portion 53 is identical to that of the non-circular extension 43 (FIG. 5). The movement chamber 54 is cut into a front face and a lower face of the disc 50, thereby forming two hooks 55 on two opposite sides of the movement chamber 54 on the lower face of the disc 50. The hooks 55 are identical in shape but located in opposite senses of direction.

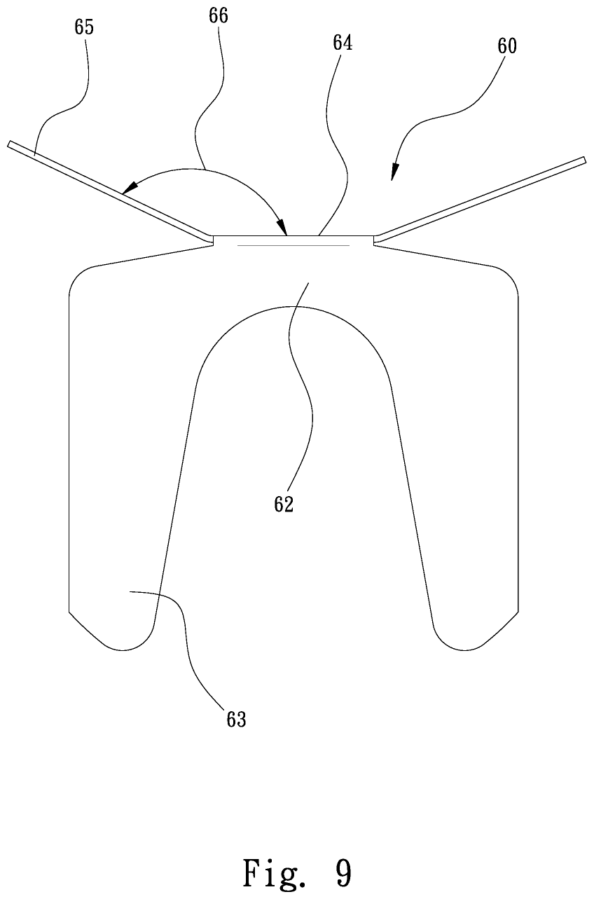

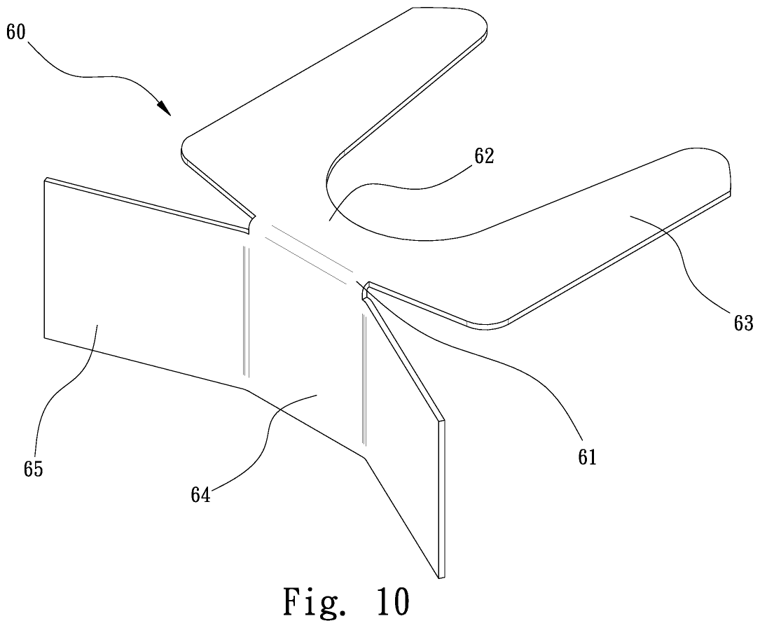

Referring to FIGS. 9 and 10, the auxiliary element 60 includes a bent connective portion 61 formed between a horizontal plate 62 and a vertical plate 64. The horizontal plate 62 is a substantially U-shaped plate including two fins 63. The vertical plate 64 includes two slant portions 65 extending from a middle portion thereof in two opposite senses of direction. Each of the slant portions 65 extends at an angle 66 of about 120° relative to the middle portion of the vertical plate 64.

Referring to FIGS. 3 through 6, the insertion of the switch assembly 40 in the handle 11 will be described. The horizontal plate 62 of the auxiliary element 60 is inserted in the secondary chamber 16. The horizontal plate 62 is rotatable on the floor 168. The vertical plate 64 is inserted in the intermediate chamber 15 of the handle 11 and supported by the horizontal plate 62 to keep the slant portions 65 in contact with the detents 30.

Most of the disc 50 is rotationally inserted in the secondary chamber 16 of the handle 11 while the hooks 55 are inserted in the intermediate chamber 15 of the handle 11. Each of the hooks 55 is located in the vicinity of the stem 33 of a corresponding one of the detents 30.

The switch 41 is inserted in the opening 161. Thus, the non-circular extension 43 is inserted in the secondary chamber 16. The non-circular extension 43 is inserted in the non-circular portion 53 of the engaging aperture 51 so that the switch 41 is rotatable with the disc 50. A selected one of the positioning recesses 45 receives the ball 167 to retain the switch 41 in a selected one of two positions. Furthermore, the lever 46 is rotationally inserted in the recess 162.

The screw 165 is driven in the screw hole 163 via the central aperture 42 of the switch 41 and the engaging aperture 51 of the disc 50 to connect the switch assembly 40 to the handle 10. In detail, the screw 165 includes a section in the central aperture 42 of the switch 41 and another section in the semi-circular portion 52 of the engaging aperture 51 and the semi-circular recess 44 of the non-circular extension 43. Thus, the switch 41 and the disc 50 are rotated relative to the handle 11 when the lever 46 is operated.

Moreover, the screw 165 extends through a gap between the fins 63 of the horizontal plate 62. Thus, the screw 165 and the auxiliary element 60 do not interfere with each other. The horizontal plate 62 is rotatable on the floor 168 about the screw 165. In addition, the fins 63 do not interfere with the insertion of the ball 167 in each of the positioning recesses 45.

In use, a selected one of the hooks 55 hooks a selected one of the stems 33 in the movement chamber 54 to engage a selected one of the detents (“selected detent”) 30 with the toothed wheel 20 and disengage the remaining one of the detents (“idle detent”) 30 from the toothed wheel 20. Accordingly, the idle detent 30 pushes one of the slant portions 65 of the vertical plate 64, thereby causing the other one of the slant portions 65 to push the selected detent 30 against the toothed wheel 20.

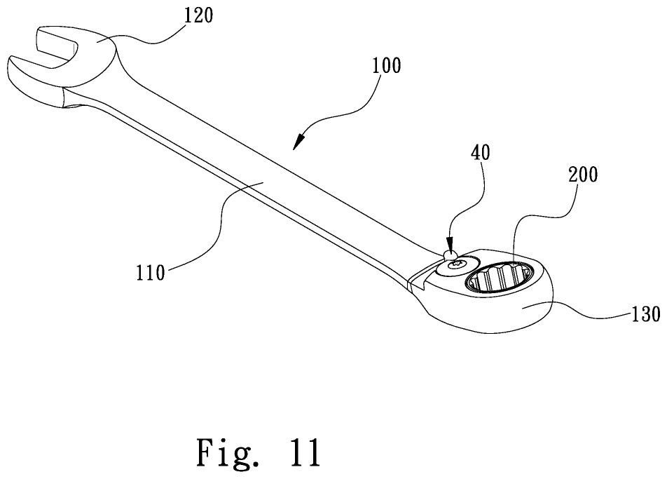

Referring to FIG. 11, there is a ratchet wrench 100 according to a second embodiment of the present invention. The second embodiment is substantially identical to the first embodiment except for several things. Firstly, a thinner handle 110 is used instead of the handle 11.

Secondly, the handle 110 includes an open-end wrench 120 instead of the grip 12.

Thirdly, a thinner head 130 is used instead of the head 13.

Fourthly, a toothed wheel 200 is used instead of the toothed wheel 20. The toothed wheel 200 is an annular element that includes a plurality of teeth (not numbered) on an internal face. Accordingly, the toothed wheel 200 does not include the non-circular insert 26, the pushing rod 25 or the ball 27.

The present invention has been described via the illustration of the embodiments. Those skilled in the art can derive variations from the embodiments without departing from the scope of the present invention. Therefore, the embodiments shall not limit the scope of the present invention defined in the claims.

1. A ratchet wrench comprising:
a head (13);
a toothed wheel (20) rotationally inserted in the head (13);
two detents (30) inserted in the head (13); and
a switch assembly (40) comprising an auxiliary element (60) comprising a horizontal plate (62) supported on the handle (11) and a vertical plate (64) extending from the horizontal plate (62) and comprising two slant portions (65);
a disc (50) comprising an engaging aperture (51) and two hooks (55) on two opposite sides of the engaging aperture (51);
a switch (41) comprising a central aperture (42) and an extension (43) inserted in the engaging aperture (51) so that the disc (50) and the switch (41) are rotatable together; and
a screw (165) inserted in a portion of the handle (11) through the central aperture (42) of the switch (41) and the engaging aperture (51) of the disc (50), wherein the switch (41) is operable to rotate the disc (50) to make one of the hooks (55) hook and engage a selected one of the detents (30) with the toothed wheel (20) while the other one of the detents (30) pushes one of the slant portions (65) so that the other one of the slant portions (65) pushes the selected detent (30) against the toothed wheel (20).

2. The ratchet wrench according to claim 1, wherein the horizontal plate (62) comprises two fins (63), wherein a screw (165) extends in a gap between the fins (63).

3. The ratchet wrench according to claim 1, wherein the auxiliary element (60) further comprises a connective portion (61) formed between the horizontal plate (62) and the vertical plate (64).

4. The ratchet wrench according to claim 1, wherein the disc (50) further comprises a movement chamber (54) between the hooks (55).

5. The ratchet wrench according to claim 1, wherein the extension (43) is a non-circular extension, wherein the engaging aperture (51) comprises a non-circular portion (53) for receiving the extension (43).

6. The ratchet wrench according to claim 1, wherein the extension (43) extends from a lower face of the switch (41) and comprises a semi-circular recess (44) next to the central aperture (42), wherein the engaging aperture (51) comprises a semi-circular portion (52), wherein the screw (165) extends in the semi-circular recess (44) of the extension (43) and the semi-circular portion (52) of the engaging aperture (51).

7. The ratchet wrench according to claim 6, further comprising a ball (167) connected to the head (13), wherein the non-circular extension (43) further comprises positioning recesses (45) one of which receives the ball (167) to keep the switch (41) in one of two different positions relative to the head (13).
